(19) United States
(12) Patent Application Publication
(10) Pub. No.: US 2014/0068408 A1
(43) Pub. Date: Mar. 6, 2014

(54) PRESENTATION OF LAYERED CONTENT DOCUMENTS IN MULTISCREEN SYSTEMS

(71) Applicants: Vincent Le Chevalier, San Jose, CA (US); Shannyn Timrott, San Jose, CA (US); Ohad Eder-Pressman, San Francisco, CA (US); Charles F. Geiger, San Jose, CA (US)

(72) Inventors: Vincent Le Chevalier, San Jose, CA (US); Shannyn Timrott, San Jose, CA (US); Ohad Eder-Pressman, San Francisco, CA (US); Charles F. Geiger, San Jose, CA (US)

(73) Assignee: CHEGG, INC., Santa Clara, CA (US)

(21) Appl. No.: 13/604,453

(22) Filed: Sep. 5, 2012

(51) Int. Cl. G06F 17/00

(52) U.S. Cl. 715/234

(57) ABSTRACT

A publishing platform manages distribution of a multilayered document to a plurality of user devices communicatively coupled to the platform. Each device executes an eReader browser application, which renders the document into a format suitable for a user to read and interact with the content. Each layer of the document has unique characteristics relating to its file size, spatial dimensions, update frequency, or interactivity, and the unique attributes of each device affect the system resources available to the eReading application executing on the device. Based on the characteristics of each layer and the attributes of the devices, the publishing platform recommends a set of layers of the document most suited for each device. The platform may automatically distribute layers to each connected device, or it may deliver the recommendation to the user and distribute layers responsive to a user input.

### CROSS REFERENCE TO RELATED APPLICATIONS

This application is related to U.S. patent application Ser. No. 13/584,715, which is incorporated by reference in its entirety.

### BACKGROUND

1. Field of the Invention

This invention relates to distribution of multilayered electronic content to a plurality of consumer devices.

2. Description of the Related Art

The rapid shift to mobile Internet services is bringing content offerings to an increasingly larger number of connected devices. Experiences previously limited to a single device are now accessible across multiple devices as high volume consumer electronic platforms such as Smart Phones, tablets, eReaders, game systems, and Internet TVs have become new channels to receive digital documents and services. Popular electronic book services leverage standardized publishing formats to seamlessly integrate and synchronize digital document reading experiences across consumer devices.

But as new digital services are progressively embedded within the original document, merging these additional content layers into a single reading experience becomes increasingly more difficult. Most importantly, as digital documents shift from a static model to a dynamic model, in which related, personalized, and social content are aggregated dynamically within the original document, publishing services must be able to manage and distribute these new content layers across a plurality of connected devices, each with unique attributes affecting the reading experience.

### SUMMARY

Embodiments of the invention provide a method for managing distribution of a multilayered document to a plurality of user devices. The multilayered document comprises a core layer of one or more pages of a publication, ingested by a publishing platform and transformed into a format suitable for web-based publication. One or more additional layers of the document comprise supplemental content associated with the pages of the core layer. The document is distributed by the publishing platform to eReading browser applications executing on one or more devices of a user, which render the content for display on each device. Each layer of the document has unique characteristics relating to its file size, spatial dimensions, update frequency, and/or interactivity.

In one embodiment, a user may access the multilayered document from a plurality of devices communicatively coupled to the publishing platform, each device having different attributes. The attributes of each device affect the system resources available to the eReading application executing on the device. Accordingly, one device may be more suitable than others for displaying and enabling user interaction with each document layer. Attributes are reported to the publishing platform, which determines a recommendation for a set of layers to distribute to each device responsive to the characteristics of each layer and at least one attribute of each device. The platform may distribute the recommended set of layers to each device for automatic implementation, or the platform may deliver the recommendation to the user.

### BRIEF DESCRIPTION OF THE DRAWINGS

FIG. 1 is a high-level block diagram of a platform environment in accordance with an embodiment of the invention.

FIG. 2 illustrates a block diagram of a multilayered content distribution system in accordance with an embodiment of the invention.

FIG. 3A is a high-level block diagram of user devices connected in a virtual network.

FIG. 3B illustrates a block diagram of a publishing platform in accordance with an embodiment of the invention.

FIG. 4 is a high-level block diagram of a computer for use as a client device, in accordance with an embodiment of the invention

FIG. 5 illustrates example attributes of various classes of user devices, in accordance with an embodiment of the invention

FIG. 6 illustrates example characteristics of various layers of a multilayered document, in accordance with an embodiment of the invention

FIG. 7A illustrates configuring multilayered content distribution to a plurality of paired user devices.

FIG. 7B is an example implementation of a multilayered content distribution configuration.

FIG. 8 is a flowchart illustrating the method for multilayered content management and distribution, in accordance with an embodiment of the invention.

FIG. 9 is a flowchart illustrating the method for configuring multilayered content distribution, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

The rapid growth of web-based publishing services and growing adoption of electronic books demonstrates the readiness of consumers to migrate from print to digital content. However, given the plethora of Internet-ready devices available to consumers, the way these consumers interact with online content is also rapidly changing. Rather than accessing information through a single computing device, users expect information to be available on many different types of devices. By leveraging the different attributes of the devices and enabling users to distribute information across multiple devices simultaneously, a more user-friendly, interactive reading experience is created.

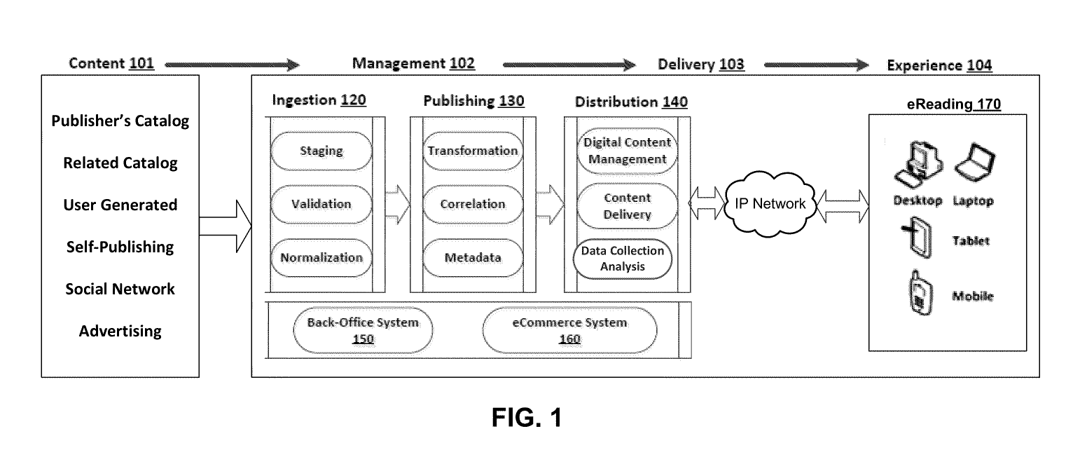

Embodiments of the invention provide a method for distributing multilayered documents to a plurality of user devices. The method is organized around an educational digital publication and reading platform configured to aggregate, manage, and distribute multilayered content. FIG. 1 is a high-level block diagram illustrating the platform environment, organized around four function blocks: content 101, management 102, delivery 103, and experience 104. These blocks are described in more detail in U.S. application Ser. No. 13/253,011, incorporated herein by reference in its entirety. Briefly, content block 101 aggregates content that will be delivered by the platform. Management block 102 comprises five blocks with respective submodules: ingestion 120, publishing 130, distribution 140, back office system 150, and eCommerce system 160. Ingestion 120 includes staging, validation, and normalization subsystems; publishing 130 includes transformation, correlation, and metadata subsystems; and distribution 140 includes digital content management, content delivery, and data collection analysis subsystems. Back-office system 150 enables business processes such as human resources tasks, sales and marketing, customer and client interactions, and technical support. The final subsystem of management block 102, eCommerce system 160, interfaces with back office system 150, publishing 130, and distribution 140 to integrate marketing, selling, servicing, and receiving payment for digital products and services. Delivery block 103 of an educational digital publication and reading platform distributes content for user consumption by, for example, pushing content to edge servers on a content delivery network. Experience block 104 manages user interaction with the publishing platform by updating content, reporting users' reading activities, and assessing network performance.

### Multilayered Content Management System

A multilayered document comprises a core document layer and one or more additional content layers. The core layer is a standalone document comprising one or more pages of a publication, and additional content layers comprise supplemental content associated with the pages of the core layer. In one embodiment, the core layer is a book, comprising one or more pages of content with text and images. In other embodiments, the core layer may be any other published document, such as self-published notes.

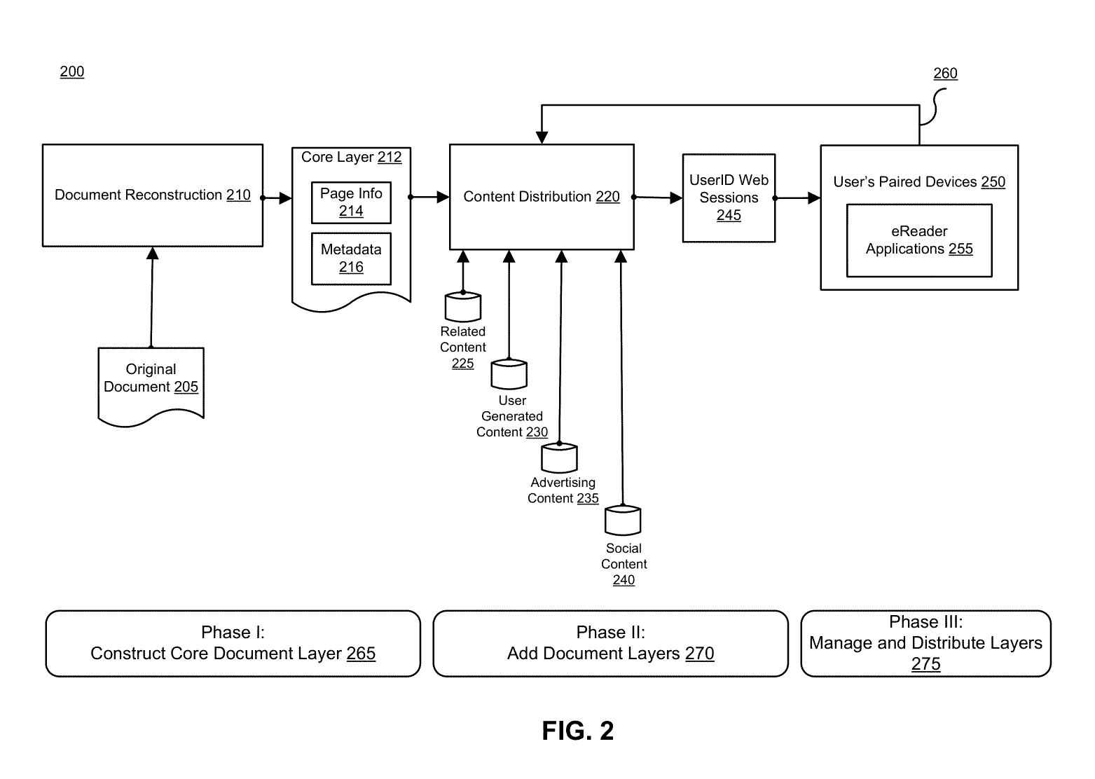

FIG. 2 is a block diagram illustrating an example of a digital publishing platform 200 for constructing, managing, and distributing multilayered documents. In one embodiment, platform 200 comprises document reconstruction system 210 and content distribution system 220. Aspects of the digital publishing platform 200 may function similarly to the ingestion system 120, the publishing system 130, and the distribution system 140 described with reference to the content distribution platform 102 of FIG. 1. Construction, management, and distribution is organized around three phases: Phase I 265 constructs a core document layer, Phase II 270 supplements the core document layer with additional document layers, and Phase III 275 organizes layer management and distribution.

The publishing platform 200 initially ingests original document 205, a published document that may be in one of a variety of different formats such as PDF, ePUB2, ePUB3, XML, HTML, and SVG. If original document 205 is in a markup language format, it may be ingested into content distribution system 220. However, if original document 205 is not in a markup language format, in Phase I 265, original document 205, e.g., a textbook, is ingested by the publishing platform into document reconstruction system 210. Reconstruction system 210 automatically identifies, extracts, and indexes all the key elements and composition of original document 205 in order to reconstruct it into a modern, flexible, and interactive HTML 5 format. The ingested documents are converted by the reconstruction process into markup language documents well-suited for distribution across various computing devices. Reconstruction system 210 reconstructs the original documents so as to accommodate dynamic add-ons, such as user-generated and related content, while maintaining page fidelity to the original document. The transformed content preserves the original page structure including pagination, number of columns and arrangement of paragraphs, placement and appearance of graphics, titles and captions, and fonts used, regardless of the original format of the source content and complexity of the layout of the original document 205.

The output of reconstruction system 210 is core document layer 212 comprising a set of basic elements of document 205: page info 214 and metadata 216. In another embodiment, core layer 212 may not be the output of reconstruction system 210, but rather the original document 205 ingested by the publishing platform 200. Page info 214 includes the pagination, number of columns and arrangement of paragraphs, placement and appearance of graphics, titles and captions, and fonts used in original document 205 such that document 205 may be reconstructed while preserving the original page structure. In various examples, metadata 216 includes product description, pricing, terms (e.g., whether the content is for sale, rent, or subscription, or whether it is accessible for a certain time period or geographic region, etc.), and a list of supplemental layers that may be purchased or downloaded in conjunction with core layer 212.

Page info 214 and metadata 216 are then passed, in Phase II 270, to content distribution system 220. Additional content layers are added to the document in Phase II 270, such as related content 225, user-generated content 230, advertising content 235, and social content 240, or any other categories of content. Related content 225 comprises material supplementing the core document, such as study guides, self-testing material, solutions manuals, glossaries, journal articles, etc. User-generated content 230 comprises annotations made by a user during an eReading session, such as highlighting or taking notes. In one embodiment, user-generated content may be self-published by a user and made available to other users as a related content layer 225. Advertising content 235 may be uploaded by advertisers or advertising agencies to the publishing platform, such that advertising content may be displayed within a layer of the document. Social content 240 may be uploaded to the publishing platform by the user or by other nodes (e.g., classmates, teachers, authors, etc.) in the user's social graph. Examples of social content 240 include interactions between users related to the document, content shared by members of the user's social graph, and many others. Each layer has unique characteristics describing its complexity, file size, spatial dimension, update frequency, or interactivity level, but page info 214 is referenced by all layers added to the document during Phase II 270 to merge all content layers into a single reading experience.

Content distribution system 220 determines the characteristics of each layer based on page info 214 and metadata 216. The location, composition, and weight of elements of each page, as described by page info 214 and metadata 216, are combined to compute a marker describing each layer associated with a page of the document. The marker is a numerical value estimating the complexity of a page of the document based on the location and composition of elements associated with the page, enabling the platform 200 to calculate the device resources required to transition from one page to the next. For example, a page comprising several high-resolution images may be assigned a larger marker than a page consisting of text. Metadata 216 may additionally or alternatively contain a layer characteristic that is qualitative or difficult to extract from the core document layer, such as characteristics relating to the types of interactions a user may have with a particular layer. For example, a layer of user-generated notes may be tagged with metadata describing a keyboard as the preferred method for creating new content within the layer.

After constructing and characterizing a multilayered document, content distribution system 220 distributes content dynamically and on-demand through web sessions 245 authenticated for a particular User ID. Web sessions 245 are created each time a user requests to access a multilayered document, and are unique for each combination of user requesting access, device from which the request is activated, and document being requested. By delivering content through authenticated web sessions 245, content distribution system 220 can protect document 205 by limiting access to the document to a particular user and set of devices, while organizing and synchronizing the distribution of multiple layers of a multilayered document to a plurality of a user's devices.

In Phase III 275, the publishing platform 200 distributes layers. Content distribution system 220 passes all content layers by web sessions 245 to eReader browser applications 255, comprising client software compatible with web browsers executing on paired devices 250. At least one eReader application is executing on each device, which may be a desktop computer, a laptop computer, a tablet, a Smart Phone, an Internet TV, or any other device capable of accessing the Internet. EReader applications 255 facilitate user interaction with content, such as reading the content, navigating between pages, annotating the content, interacting with advertisements, and creating social content. Contrary to other existing digital publishing services, the educational digital publication and reading platform of the present invention allows the user to access content without downloading a specific reading application from the publisher. Rather, eReader applications 255 construct document pages using structureless HTML5 elements such as page info 214 and metadata 216. It should be noted that eReader applications 255 comprise eReading applications as well as supplemental content applications that function in the browser environment to support the user's eReading activities and overall engagement with the multilayered documents distributed by the platform, such as user-generated applications, social applications, and advertising applications.

EReader applications 255 integrate user reading activities and log data to synchronize the activities across all paired devices 250. Logged data is reported back to content distribution module 220 as shown by reference 260, and thereby used to update and/or create additional content layers in Phase II 270. An end user may also request additional layers during an eReading web session, by, for example purchasing a related content layer 225 while reading the core document layer 212. Accordingly, Phases II 270 and III 275 may be repeated as necessary during a web session 245 to dynamically update and aggregate all document content into a seamless user experience.

### Distribution of Multilayered Content

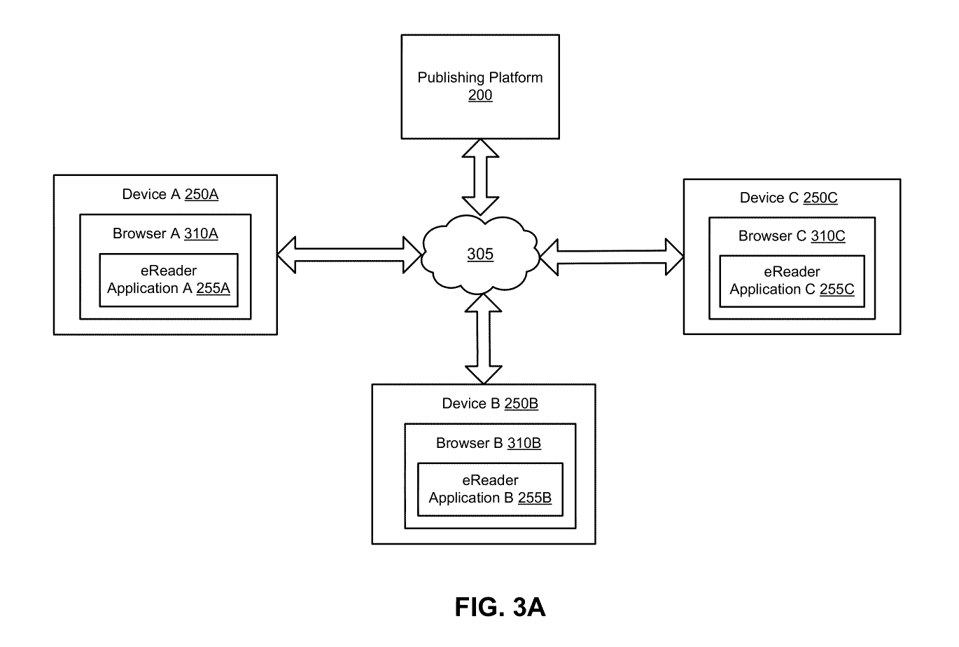

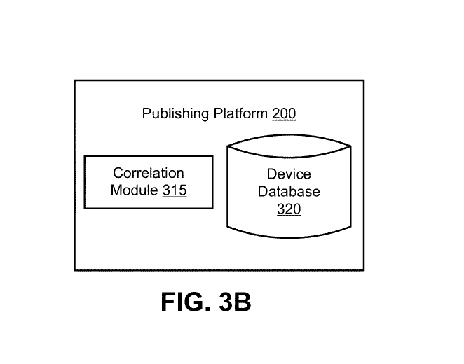

Content available for purchase, including catalogs, indexes, and related contents, are made available to end users to order from within eReader applications 255. The user interacts with applications 255 executing on one or more devices 250 to order desired content from publishing platform 200 and access previously-purchased content. FIG. 3A illustrates an example environment in which multiple devices are used by a single end user to read and interact with a multilayered document distributed by platform 300. Three user devices are shown in FIG. 3A, but a user may use any number of his or her devices to access a document hosted by platform 200. Each device 250 executes a web browser 310, and at least one eReader application 255 operates within each browser 310.

Communication between platform 200 and devices 250 is enabled by network 305. In one embodiment, the network 305 uses standard communications technologies and/or protocols. Thus, the network 305 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 305 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 305 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 305 can also include links to other networks such as the Internet.

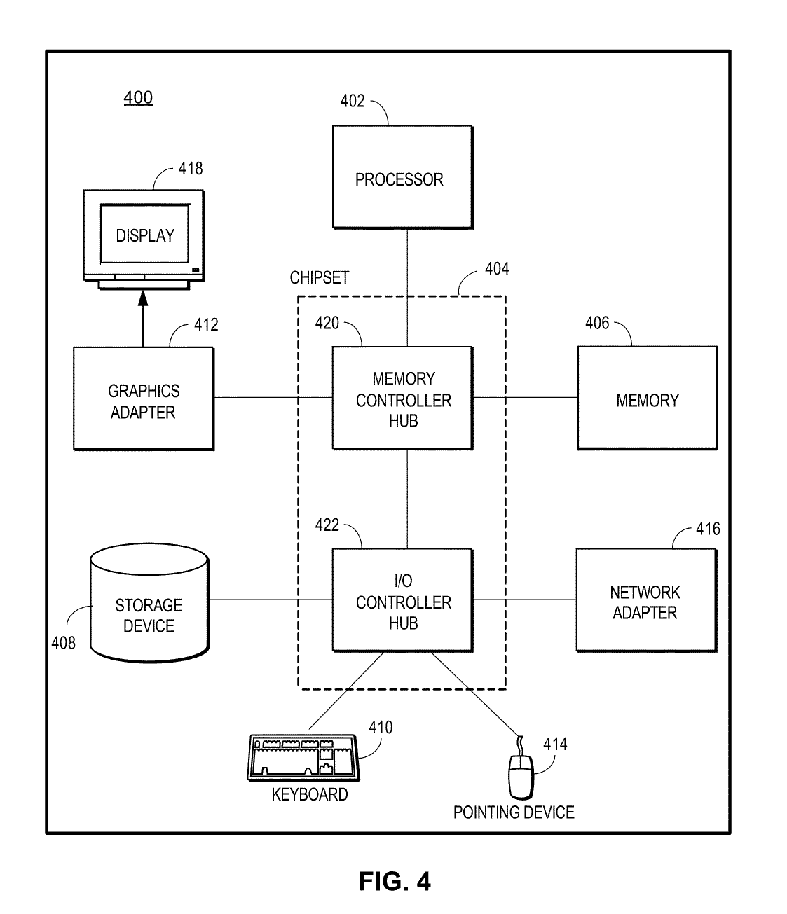

A high-level block diagram of a computer 400, as an example of a user device 250, is illustrated in FIG. 4. Illustrated are at least one processor 402 coupled to a chipset 404. The chipset 404 includes a memory controller hub 420 and an input/output (I/O) controller hub 422. A memory 406 and a graphics adapter 412 are coupled to the memory controller hub 420, and a display device 418 is coupled to the graphics adapter 412. A storage device 408, keyboard 410, pointing device 414, and network adapter 416 are coupled to the I/O controller hub 422. Other embodiments of the computer 400 have different architectures. For example, the memory 406 is directly coupled to the processor 402 in some embodiments.

The storage device 408 is a non-transitory computer-readable storage medium such as a hard drive, compact disk read-only memory (CD-ROM), DVD, or a solid-state memory device. The memory 406 holds instructions and data used by the processor 402. The pointing device 414 is a mouse, track ball, or other type of pointing device, and is used in combination with the keyboard 410 to input data into the computer 400. The graphics adapter 412 displays images and other information on the display device 418. The network adapter 416 couples the computer 400 to a network. Some embodiments of the computer 400 have different and/or other components than those shown in FIG. 4. The types of computer 400 can vary depending upon the embodiment and the desired processing power.

When a user requests to access a multilayered document from each device 250, the device is authenticated and connected to the publishing platform 200 through network 305. Browser 310 reports to platform 200 an identifier of the user requesting access, an identifier of the content being requested, and an identifier of the device for which access is requested. Based on the combination of these identifiers, platform 200 may authenticate each session either by authenticating access to all requested layers on a particular device or by authenticating access to a subset of the requested layers. Alternatively, platform 200 may deny the request. When a session is authenticated, platform 200 delivers time-sensitive URLs to browsers 310 indicating a location of the requested content.

Authenticated devices 250 are then communicatively coupled, through network 305, to a user account within platform 200 that is specific to the user and the document. The result is a virtual network of a user's devices requesting content from and reporting activities to a centralized location. Reported events comprise user interactions with the content during an eReading session facilitated by browser application 255, including, for example, navigating between pages, highlighting text, taking notes, printing pages, disconnecting from the platform and reconnecting, creating social content, interacting with social content, interacting with advertising content, etc. These activities may be reported to platform 200 to track and manage content delivery or to publish content, such as user-generated content.

In one embodiment publishing platform 200 comprises a correlation module 315, as shown in FIG. 3B. Correlation module 315 determines attributes of connected devices and correlates the attributes to characteristics of the requested document. Device attributes may include performance, display, mobility, connectivity, interactivity, available storage, or any other information about devices 250 that is relevant to a user's interaction with a multilayered document. For example, performance may relate to a combination of one or more of accessible memory, access time, reliability factor, type of access, CPU class, properties of browser 255, operating system, and other system properties. Attributes related to display may include, for example, size of the display, pixel resolution, color resolution, pixels per inch, or refresh rate. Mobility may be determined by assessing the class of a device; e.g., a Smart Phone will likely have greater mobility than a desktop PC. Connectivity describes the effective bandwidth available for communicating with each device, comprising the volume of network activity and the time required for each device to request and receive content from platform 200. Interactivity attributes relate to the type of interactions available for each device, such as the means available for navigating between pages or means for creating user-generated content. For example, a device with a keyboard and mouse may have greater interactive capabilities than a device with only a pointing device. Storage quantifies the available memory of each device, such as cache size, available random access memory, or hard disk capacity.

Device attributes may be stored in a device database 320 coupled to the platform 200. When a request to access content is received from a device 250, correlation module 315 receives the device identifier and determines whether attributes of the device are stored in the device database 320. If not, correlation module 315 requests from device 250 an estimate of the device's resources. Browser 310 in response reports an estimate of the resources available to the browser, such as the speed, memory size, authorization mode for memory increase, resolution, type, version number, etc. Other attributes may be estimated based on a generalized characterization of a device. For example, if a particular laptop model is not listed in the device database 320, correlation module 315 may estimate that the laptop has certain features (such as a keyboard; a particular operating system; a given processor speed; a display size of, for example, 1366×768 pixels; or a relatively high degree of mobility) based on attributes of other laptop models listed in database 320. If attributes of device 250 are stored in device database 320, correlation module 315 retrieves the attributes.

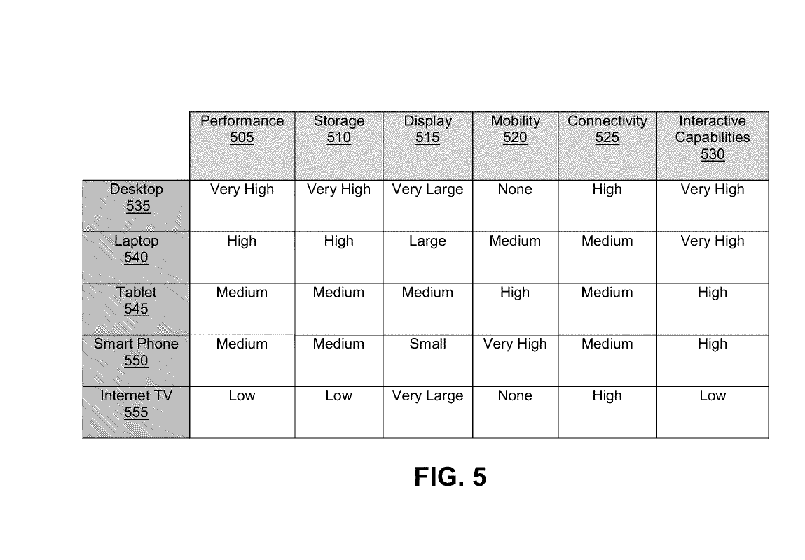

Various examples of classes of user devices and their attributes are illustrated in the table of FIG. 5. A user may access a multilayered document from a desktop 535, laptop 540, tablet 545, Smart Phone 550, or Internet TV 555. Other devices may also be used to access the document. One or more of the devices 535-555 may be configured as computer 500, or may be configured with additional or fewer components, such as a virtual keyboard in place of keyboard 410 and no pointing device 414. Display device 418 may be touch-based in one or more devices. The attributes stored in device database 320 may be qualitative or quantitative assessments of each device 250. For example, a laptop computer 540 listed in device database 320 may be described as having high performance 505, very high storage 510, large display 515, medium mobility 520, medium connectivity 525, and very high interactive capabilities 530. Correlation module 315 then assigns a numerical score to each attribute. Scores may be assigned manually, or may be updated over time by supervised learning methods. For example, as platform 200 distributes content to an increasingly wider variety of user devices, it will be able to build an increasingly more accurate model for defining attributes based on the large number of web sessions. In one embodiment, the score is a number on a scale of arbitrary units. For example, the storage attribute 510 may be scored on a scale from one (indicating very little available storage) to five (indicating a very large quantity of available storage). The storage attribute 510 of laptop 540 may receive a score of four on such a scale. Other attributes besides those listed in FIG. 5 may additionally or alternatively be stored in device database 320, determined by correlation module 315, or reported to platform 200. The values for the attributes illustrated in FIG. 5 are provided by way of example only: the attributes may vary significantly between devices in the same class, and may fluctuate over time based on a user's eReading activities.

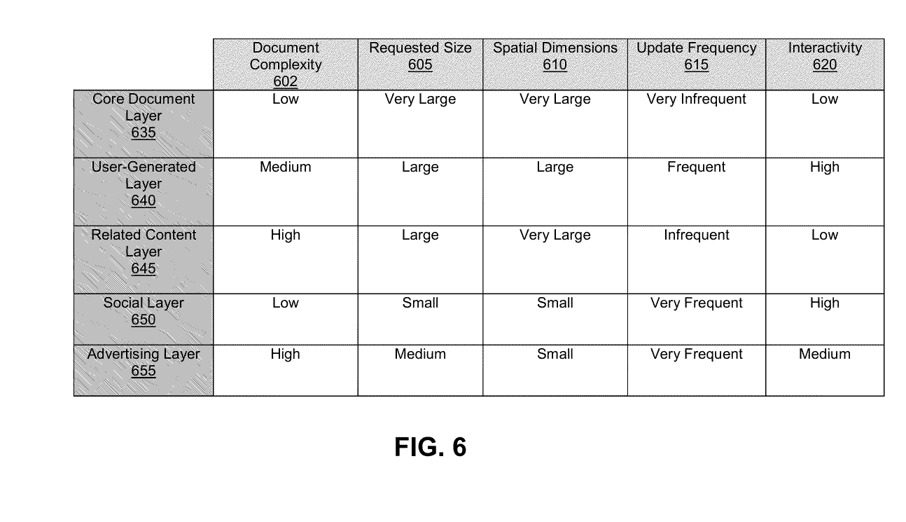

In a similar manner, correlation module 315 assigns a numerical score to the characteristics of each document layer. Various examples of layer characteristics are illustrated in the table of FIG. 6. A multilayered document may include, for example, a core document layer 635, a user-generated notes layer 640, a related content layer 645, a social layer 650, and an advertising layer 655. The document may comprise fewer or additional layers. Content distribution system 220 determines characteristics of each layer as it is ingested by the platform 200 or as it is created or modified during an eReading session. For example, content distribution system 220 may determine, based on structural information and metadata, that the core book layer 635 has a very large file size 605, very large spatial dimensions 610, and very infrequent update frequency 615. Correlation module 315 ranks each characteristic on a scale corresponding to the scale used to rank device attributes. For example, the requested size characteristic 605 may be scored on a scale from one (indicating very small file size) to five (indicating very large file size). The requested size characteristic 605 of core layer 635 would therefore receive a score of five. Other characteristics besides those listed in FIG. 6 may additionally or alternatively be determined by platform 200. The qualitative assessment of the characteristics illustrated in FIG. 6 is provided by way of example only: the characteristics may vary significantly between similar layers in different documents, and the characteristics of each layer may also change during an eReading session.

Based on the numerical score assigned to characteristics of each layer and the attributes of each device that are relevant to the layer characteristics, correlation module 315 computes a correlation between the layers and devices. In one embodiment, correlation module 315 divides the score assigned to the device attribute by the score assigned to the layer characteristic. For example, a score of four assigned to a device's storage attribute 510 may be divided by a score of five assigned to a layer's requested size characteristic 605 to yield a correlation of 0.8.

The variation of attributes between devices ensures that, even though every device executes a similar eReader application 255, the system resources available to each application will not be uniform. Because each layer of a multilayered document requires different resources, some classes of devices will be more suited to displaying some content layers than others. The correlation between device attributes and layer characteristics can be used to assess the suitability of a device for rendering each layer. For example, correlation module 315 may determine a threshold correlation value, such as 1.0. If the correlation between a device attribute and a layer characteristic is greater than the threshold value, the device is likely to have sufficient resources for rendering the layer and allowing optimal user interaction with the content. Correlation module 315 may also set a second threshold value that is lower than the first threshold value, such as 0.5. If a correlation is between 0.5 and 1.0, the device may be able to render the layer but performance will not be optimal. If a user requests to access a content layer on a device for which the correlation is in this intermediate range, publishing platform 200 may issue a warning to the user indicating that the device is not optimal for the layer. When a correlation value is below the lower threshold, platform 200 may deny the request to access a layer on a particular device.

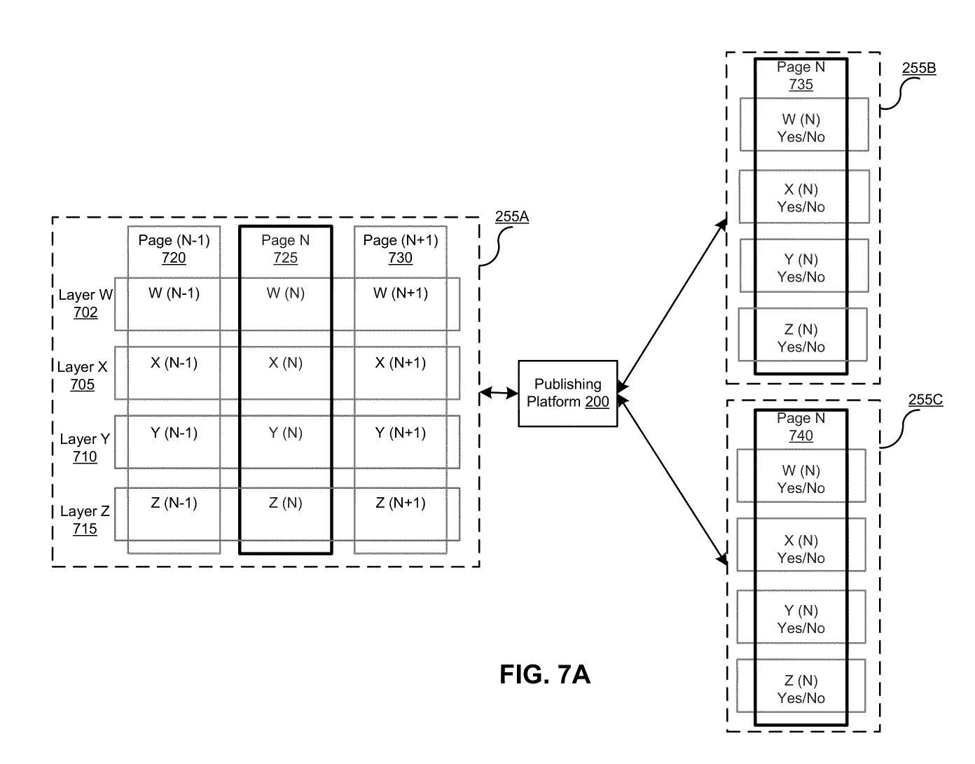

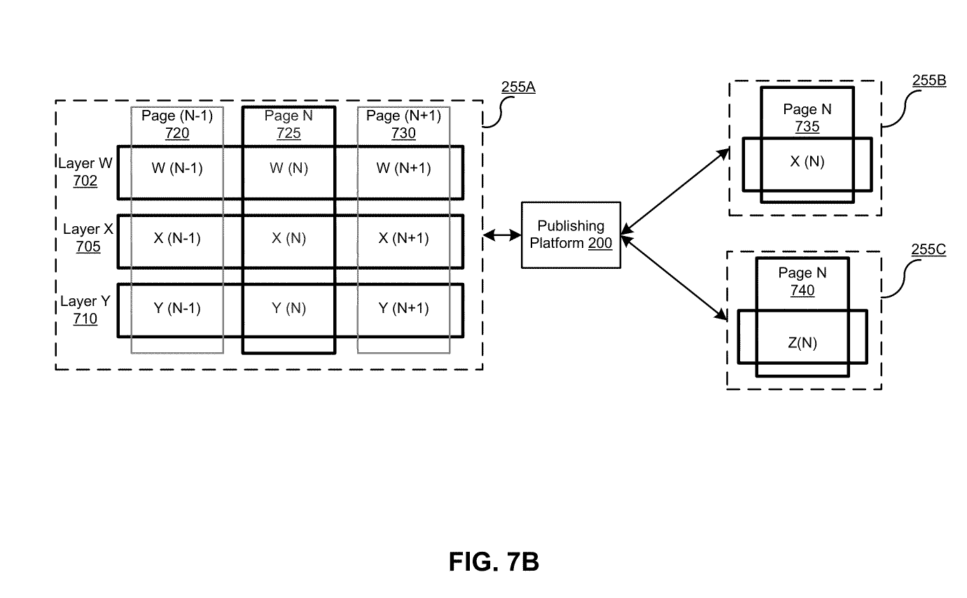

When multiple devices are used to read and interact with one document, the inherent differences between the devices may be leveraged to display each layer on the device or devices most suited to the characteristics of that layer. FIG. 7A illustrates one embodiment of configuring multilayered content distribution to a plurality of paired user devices, in which different combinations of layers may be distributed to different devices. Four document layers (Layer W 702, Layer X 705, Layer Y 710, and Layer Z 715) and three eReader applications 255 are shown in FIG. 7A as an example, but the document may have any number of layers and any number of user devices may be connected. The document comprises a plurality of pages defined by the core layer 212, with additional content layers associated with each page. One page of the core document is rendered by eReader applications 255 with associated layers, although layers associated with more than one page may be shown at one time. For example, notes associated with multiple pages of the core document may be displayed in a side bar next to one page. In FIG. 7A, layers are represented by boxes with larger horizontal dimensions, and pages are represented by boxes with larger vertical dimensions. Pages are rendered by browser applications 255 represented by dashed boxes in FIG. 7A.

While a user is reading page N of the document, one or more of the paired devices may cache a portion of the document. In one embodiment, one or more of the devices may cache pages close to page N to enable quick access to the content the user is mostly likely to request to access after page N. By way of example, FIG. 7A illustrates device 250A caching two pages—page (N−1) 720 and page (N+1) 730—in addition to rendering page N 725. Device 250B and device 250C cache no pages in the example shown in FIG. 7A, but only display, respectively, page N 735 and page N 740. The number of pages cached by each device may vary in response to the capabilities of each device and the memory required to process each page.

The number of layers displayed and pages cached may vary between devices 250. Different configurations may improve user interaction with the document by distributing each layer to the device most suited to the layer's characteristics. For example, a device with a larger display, such as a desktop computer or an Internet TV, may be more suitable for using to read a large textbook, while a more mobile device, such as a Smart Phone or tablet PC, may be more suitable for using to interact with social content. Alternatively, one or more layers may be distributed based on the physical location of the user. For example, a related content layer may be available in a university library that would not be accessible when the user is in a different location. Furthermore, each set of devices used to access the document creates a unique user experience: a user would interact differently with the combination of a desktop and laptop, for example, than with the combination of a desktop, a Smart Phone, and an Internet TV.

Because browser applications 255 executing on each device 250 report their estimated available resources to publishing platform 200 and thereby provide key data for defining attributes of the devices, platform 200 may determine optimal or near-optimal sets of layers to be delivered to each device by matching the properties of each layer to one or more attributes of each device. In one embodiment, platform 200 determines an optimal set of layers by correlating characteristics of each layer with attributes of the connected devices. One or more correlations may be computed for each layer of the document. If more than one correlation is computed (i.e., multiple characteristics of each layer are correlated with multiple attributes of a single device), platform 200 may aggregate and/or average the correlations for each device to compute a total or average score. For example, given correlations of 0.8, 0.7, 1.0, and 1.2 computed between four characteristics of a layer and four attributes of a device, the device's total score (with respect to the particular layer) would be 3.7. One or more devices with the highest score(s) are determined to be the optimal devices for receiving and rendering each layer. The same process may be repeated for all layers of the document, generating sets of layers to distribute to each device.

Each optimal set may be dynamically updated by platform 200 during an eReading session as the number and type of connected devices 250, the attributes of the devices, the characteristics of each page and layer, or the frequency and type of user interaction with each layer change throughout the session. The attributes stored in device database 320 may be only a general description of a device's expected connectivity, for example, which is likely to vary between eReading sessions and during a single eReading session. To account for differences between attributes of each device stored in device database 320 and actual attributes of each device, publishing platform 200 may update attributes as browsers 310 report activities. For example, platform 200 may analyze the performance of each device as it renders each page or set of pages, and adjust the performance attribute of each device based on the actual measured performance. As the attributes change, the correlation between the attributes and relevant layer characteristics will also change and therefore may necessitate distributing a layer to a different device.

In one embodiment, publishing platform 200 automatically distributes the optimal or near-optimal set of layers to each device. Platform 200 may alternatively determine the optimal sets but present the information to the end user rather than automatically distributing layers. The end user may then configure layers according to his or her desired interactions with the document. Platform 200 may recommend a configuration by presenting to the user a list of layers comprising each optimal set. For example, platform 200 may cause one or more browsers 310 to generate a dialog box informing the user of the set of layers optimal for each device, or informing the user that a particular device has insufficient resources to render a particular layer. Recommendations may be delivered when each device initially connects to platform 200, or may be delivered during an eReading session as the layers comprising each optimal set are updated. The user may then configure layers in accordance with the recommendations, if desired.

A user may implement a configuration of layers in a variety of ways. Layers may be distributed to one device based on user input at the device, or user input at one device may change the layers distributed to a second device. For example, a user may use a pointing system, such as a keyboard and/or mouse, to select one or more layers on a device and drag the selected layers to another paired device. The user may alternatively use finger-based navigation to swipe one or more layers from a touch-enabled device to another paired device. When interacting with a gesture motion tracking capable device, the user may use a hand gesture to select and move one or more layers, or when interacting with a voice recognition capable device, the user may use voice commands to configure layers. The user may additionally or alternatively define one or more default configuration settings that are applied across all web sessions. For example, the user may create a setting that automatically distributes one or more layers to a particular device whenever that device is connected to platform 200. The user input may also comprise an activity related to reading the document. For example, the request to access a next page may push an advertisement, as part of an advertising layer, to one or more connected devices.

FIG. 7B illustrates an example configuration of the layers shown in FIG. 7A. In the example shown, three layers of content—Layer W 702, Layer X 705, and Layer Y 710—are rendered by browser 255A. Devices B and C each display one layer: Layer X is rendered by browser application 255B and Layer Z is rendered by browser application 255C. Any number of layers may be distributed to any device, and no device is required to display all layers simultaneously. For example, Layer Z as illustrated is only displayed by eReader application 255C. One page of the core layer 212 and/or the document layers associated with the page is displayed by each device at any given time. For example, page N 725, page N 735, and page N 740 are all associated with the same page of the core layer 212, but as the layers are distributed in FIG. 7B, page N 725 consists of layer W 702, layer X 705, and layer Y 710; page N 735 consists of layer X 705, and page N 740 consists of layer Z 715. The configuration of layers may change throughout a reading session as, for example, content is added to or subtracted from the layers, a user moves layers between connected devices, or additional devices are connected to or disconnected from platform 200. For example, a user may move layer Y 710 from device A to device B, changing the constitution of page N 725 to layer W 702 and layer X 705 while page N 735 is changed to consist of layer X 705 and layer Y 710.

When one or more layers of the same document are distributed to a plurality of connected user devices, all devices communicate with publishing platform 200 to request content, report changes to content, and report device attributes. All changes made to the document content from any user device are stored by platform 200 and delivered to the other connected devices. For example, a user may use one device to advance to a next page while reading a document distributed to multiple paired devices. The eReader application 255 reports the activity “Next Page” to the publishing platform 200, which logs the activity and distributes the next page of the document to all the devices. From the user's perspective, the command to access the next page is applied to all paired devices such that all devices advance simultaneously to the next page. The platform 200 may also synchronize the activity across all layers. Although the command to access the next page is issued in the context of one layer (e.g., the next page of the core document is requested), all layers advance in response to the command (e.g., user-generated content advances from content related to the current page to content related to the next page).

Communication may be initiated by either platform 200 or connected devices 250; each device 250 may pull content from platform 200, or platform 200 may push content to each device 250. Alternatively, platform 200 may support a hybrid push/pull system, enabling synchronization of content across multiple devices and a plurality of layers. For example, when a user requests to read a next page on device 250A, browser application 255A may pull the next document page from platform 200. At the same time, platform 200 pushes the next page to the other connected devices 250, updating the content distributed to each device as it becomes relevant without requiring the devices to continuously request new content from platform 200.

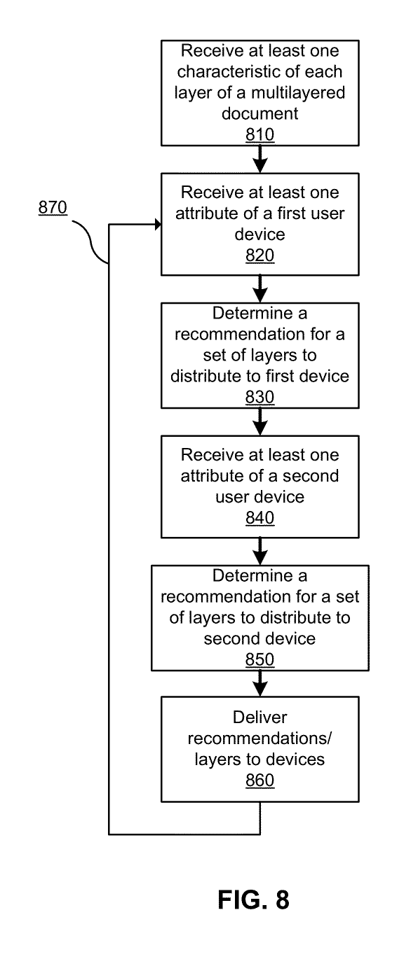

A process for managing distribution of a multilayered document to a plurality of user devices is outlined in the flowchart of FIG. 8. In the described embodiment, the steps of the method are performed by the publishing platform 200. Other embodiments perform the illustrated steps in different orders, and/or perform different or additional steps.

At least one characteristic of each layer of the multilayered document is received 810 by platform 200. Characteristics may include, for example, the file size, the spatial dimensions, the frequency of updates to the layer, or other characteristics. In one embodiment, platform 200 determines layer characteristics by extracting structural page information from an ingested document and calculating a complexity of the page based on the structural information. Structural page information may describe pagination; number of columns and arrangement of paragraphs; placement and appearance of graphics, titles, and captions; and fonts; which platform 200 uses to determine the file size of each page. In another embodiment, metadata associated with a layer may comprise information describing a relevant layer characteristic.

The platform 200 receives 820 at least one attribute of a first user device. Attributes may be related to the device's performance, storage, display, mobility, connectivity, interactivity, or other quantitative or qualitative features. In one embodiment, devices report attributes to platform 200 when initially connecting to the platform 200 and repeatedly throughout a user's eReading session. Because the attributes of connected devices may be highly varied, the resources available to eReader applications executing on each device will not be uniform.

Platform 200 determines 830 a set of layers to distribute to the first device based on the attributes of the first device and characteristics of the layer of the document. In one embodiment, platform 200 determines the set by computing a correlation between each device attributes and characteristics of each layer. The correlation is a numerical value assessing the similarity between the resources required by each layer and the resources offered by each device. In one embodiment, the determined set is delivered 860 to an end user as a recommendation for configuring layers.

Similarly, platform 200 receives 840 at least one attribute of a second user device and determines 850 a set of layers to distribute to the second device based on computing a correlation between each device attribute and characteristics of each layer. The set of layers may be delivered 860 to the user as a recommendation. Alternatively, platform 200 may deliver 860 the set of layers determined for each device without delivering a recommendation to the user. Steps 820-860 may be repeated for all devices of a single user connected to platform 200.

Connected devices may continuously report user activities and device interactions related to the multilayered document, as represented by arrow 870. Platform 200 may update the optimal sets at any time during an eReading session based on the device interactions, and distribute the optimal set or recommendations listing the optimal set to each device.

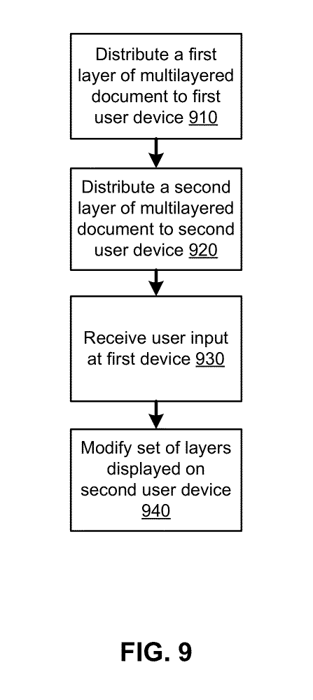

In one embodiment, platform 200 changes the layers distributed to each device in response to a user input at one or more of the devices. The method for controlling layers of a multilayered document distributed to a plurality of paired user devices, responsive to a user input, is outlined in the flowchart of FIG. 9.

At least one first layer of the multilayered document is distributed 910 by platform 200 to a first user device. At least one second layer of the document is distributed 920 to a second device of the same user. The layers distributed to each device may be, in one embodiment, the optimal set of layers determined by platform 200 to match the attributes of each device. Browser applications executing on each device render one page of each distributed layer at a time, and enable user interaction with the content of each page.

Platform 200 receives 930 a user input at the first device. The user input, received by an eReading browser application and reported to platform 200, may be a selection of layers to distribute to a second device. Selection may be enabled by a pointing system, finger-based navigation, a hand gesture, or a voice command. Alternatively, the user input may be the definition of a default set of layers to be distributed to a connected device 250, or an activity related to reading the multilayered document such as requesting a next page, creating user-generated content, or interacting with social or advertising content.

Responsive to the user input received at the first device, platform 200 modifies 940 one or more layers displayed on the second device. Modification may comprise distributing a new layer, removing a layer, or updating the content of a layer. For example, a user may input a command at a first device to move a layer from the first device to the second device, requesting platform 200 to distribute the layer to the second device. The user input may alternatively be a request to view a next page of the document on one device, which causes platform 200 to update the content rendered by the eReader application on the second device to the content associated with the next page.

### Additional Configuration Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for managing distribution of a multilayered document, the method comprising:
accessing the multilayered document, the multilayered document comprising a core layer and one or more additional layers, wherein the core layer comprises one or more pages of a publication and wherein the one or more additional layers comprise supplemental content associated with the pages;
receiving at least one characteristic of each layer of the multilayered document;
receiving at least one first attribute of a first device of a user, the first device communicatively coupled to a publishing platform and capable of executing an eReader browser application;
determining by a computer a first recommendation for a first set of layers of the multilayered document to be rendered in an eReader browser application executing on the first device, the determination based on the at least one characteristic of each layer and the first attribute;
receiving at least one second attribute of a second device of the user, the second device communicatively coupled to the publishing platform and capable of executing an eReader browser application; and
determining by a computer a second recommendation for a second set of layers of the multilayered document to be rendered in an eReader browser application executing on the second device, the determination based on the at least one characteristic of each layer and the second attribute, wherein the first set is different from the second set.

2. The method of claim 1, wherein determining a first recommendation comprises computing a correlation between the at least one characteristic of each layer and the first attribute.

3. The method of claim 1, further comprising:
distributing the first recommended set of layers to the first device; and
distributing the second recommended set of layers to the second device

4. The method of claim 1, further comprising
receiving a user input; and
responsive to the user input, distributing at least one first layer of the document to the first device and at least one second layer of the document to the second device.

5. The method of claim 3, wherein the user input comprises a preset preference for the at least one first layer and the at least one second layer.

6. The method of claim 1, wherein the at least one attribute is related to one selected from the group consisting of: performance, storage, display, mobility, connectivity, and interactivity.

7. A method for distributing a multilayered document, the method comprising:
accessing the multilayered document, the multilayered document comprising a core layer and one or more additional layers, wherein the core layer comprises one or more pages of a publication and wherein the one or more additional layers comprise supplemental content associated with the pages;
distributing from a publishing platform a first set of layers of the multilayered document to a first device of a user for rendering in a first session of an eReading browser application executing on the first device, the first device communicatively coupled to the publishing platform;
distributing from the publishing platform a second set of layers of the multilayered document to a second user device for rendering in a second session of an eReading browser application executing on the second device, the second device communicatively coupled to the publishing platform, wherein the second set is not identical to the first set and the first session overlaps in time with the second session;
receiving from the first device a user input entered at the first device; and
responsive to the user input, sending a communication from the publishing platform to the second device to modify the second set of layers.

8. The method of claim 7, wherein the user input comprises an identification of one or more layers to add to the second set.

9. The method of claim 7, wherein the user input comprises an identification of one or more layers to remove from the second set.

10. The method of claim 7, wherein the user input comprises changing on the first device content associated with a layer distributed to both the first device and the second device.

11. The method of claim 7, wherein modifying the second set of layers comprises distributing an additional layer of the multilayered document.

12. The method of claim 7, wherein modifying the second set of layers comprises updating on both the first device and the second device the change made to the content associated with the layer.
